(19) United States
(12) Patent Application Publication
(10) Pub. No.: US 2011/0078087 A1
(43) Pub. Date: Mar. 31, 2011

(54) SYSTEMS AND METHODS FOR PROVIDING AN ASSET TITLE CORRESPONDING TO AN ASSET

(75) Inventors: Don Reed Brown, Salt Lake City, UT (US); James D. House, Layton, UT (US); Douglas M. Erickson, Centerville, UT (US)

(73) Assignee: Partnet, Inc., Salt Lake City, UT (US)

(21) Appl. No.: 12/893,920

(22) Filed: Sep. 29, 2010

Related U.S. Application Data
(60) Provisional application No. 61/247,466, filed on Sep. 30, 2009.

(51) Int. Cl. G06Q 99/00

(52) U.S. Cl. 705/317

(57) ABSTRACT

A method for hosting an asset title is described. An asset title is received from a first user device. The asset title is stored. The method also includes communicating with an index to create a master title status and location record. The method may be performed by a registry.

### RELATED APPLICATIONS

This application is related to and claims priority from U.S. Provisional Patent Application Ser. No. 61/247,466 filed Sep. 30, 2009, for “SYSTEMS AND METHODS FOR PROVIDING AN ASSET TITLE CORRESPONDING TO AN ASSET,” which is incorporated herein by reference.

### TECHNICAL FIELD

The present disclosure relates generally to communication systems. More specifically, the present disclosure relates to systems and methods for providing an asset title corresponding to an asset.

### BACKGROUND

Wireless communication systems are widely deployed to provide various types of communication content such as voice, video, data, and so on. These systems may be multiple-access systems capable of supporting simultaneous communication of multiple terminals with one or more base stations.

With the advent of online auctions, purchasing of items from complete strangers has increased dramatically. Furthermore, the buyer of an item may be unable to inspect the item to determine the authenticity and condition of the item. Asset tracking of real property is currently performed by counties and asset tracking of automobiles is currently performed by the state. However, asset tracking of other properties aside from real estate and automobiles is currently not performed.

### BRIEF DESCRIPTION OF THE DRAWINGS

FIG. 1 shows a communication system with multiple user devices;

FIG. 2 is a block diagram illustrating a communication system with an index;

FIG. 3 is a block diagram illustrating an asset title for use in the present systems and methods;

FIG. 4 is a flow diagram of a method for creating an asset title corresponding to an asset;

FIG. 5 is a flow diagram of a method for hosting an asset title;

FIG. 6 is a flow diagram of a method for providing assistance to the owner of an asset title during a sale; and

FIG. 7 illustrates certain components that may be included within a wireless device that is configured in accordance with the present disclosure.

### DETAILED DESCRIPTION

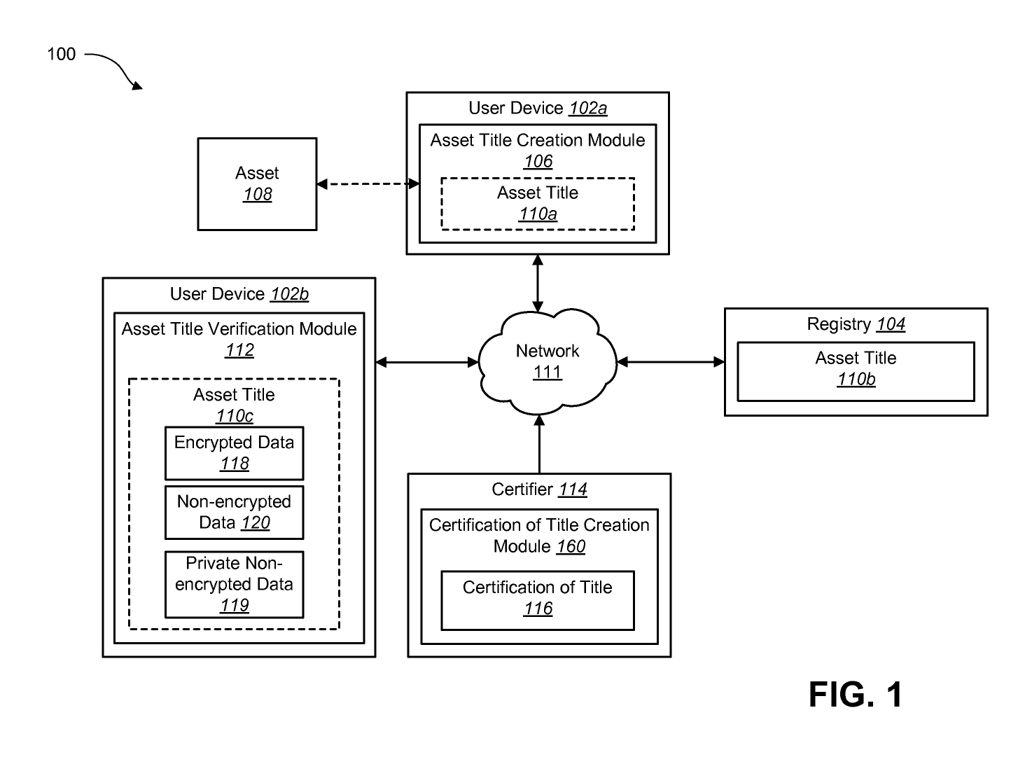

FIG. 1 shows a communication system 100 with multiple user devices 102. The communication system 100 may be a wired or wireless communication system. The communication system 100 may include a registry 104 in electronic communication with one or more user devices 102 via a network 111. There may be multiple registries 104. A registry 104 may be a computing device (such as a server) that includes one or more asset titles 110b.

A registry 104 may specialize in asset titles 110 for particular types of commodities or industries. A registry 104 may also specialize in usability or security. In one configuration, each registry 104 may include asset titles 110 that are a specific type. For example, a registry 104 may only include asset titles 110 corresponding to watches. In another configuration, a registry 104 may include many different types of asset titles 110.

A registry 104 may be controlled by a third party such as a retailer. For example, a retail store may manage a registry 104 associated with assets 108 sold by the retailer. In one configuration, the registry 104 may only (or primarily) include asset titles 110b corresponding to assets 108 sold by the retailer. Alternatively, a registry 104 may be controlled by a third party that only manages asset titles 110 (and is not involved in the retail of any other goods or services).

An asset title 110 may be located on only one registry 104. However, an asset title 110b may be transferred between registries 104 as appropriate. For example, a particular registry 104 may offer discount services according to the needs of a consumer. In this way, an asset title 110 could be transferred between two registries 104 that are each managed by a different third party.

A user device 102 may be any computing device capable of communicating with the registry 104. For example, a user device 102 may be a personal computer, a mobile device such as a cell phone or a smart phone, a personal data assistant (PDA), etc. The registry 104 may communicate with the one or more user devices 102 over the network 111.

The network 111 may represent the Internet, one or more wide area networks (WANs), one or more local area networks (LANs), etc. The network 111 may be implemented using wired and/or wireless communication technologies and may use any available protocols to pass data between the various illustrated devices and entities. In one configuration, a user device 102 may access a webpage hosted by the registry 104. The user device 102 may then verify that the asset title 110b is located on the registry 104.

The communication system 100 may include a first user device 102a. The first user device 102a may be referred to as the asset title creator. The first user device 102a may include an asset title creation module 106. The asset title creation module 106 may allow creation of an asset title 110a by the first user device 102a. The asset title 110a may be associated with an asset 108. An asset 108 may be tangible or intangible. For example, a tangible asset 108 may be a wrist watch, a comic book, an animal, an automobile, etc. Intangible assets 108 may include the right to use or lease a condominium, the right to a particular service (such as a janitorial service or use of a fitness center), etc. The asset title may include any number of factual information records relating to the title, such as detailed descriptions, pictures, etc.

The first user device 102a may be a computing device used by the owner of the asset 108 to create the asset title 110. In one configuration, the first user device 102a may be a computing device located in a retail location managed by the controller of the registry 104. Thus, a variety of different user devices 102a may be used to create an asset title 110.

The first user device 102a may send the created asset title 110a to the registry 104. In one configuration, the first user device 102a may send the created asset title 110a to the registry 104 via the network 111. The registry 104 may maintain the asset title 110b. For example, the registry 104 may maintain a database of asset titles 110b corresponding to many different assets 108. The entity operating the registry 104 may set up various fee services for hosting an asset title 110b. For example, an entity managing a registry 104 may charge an acquisition fee to begin hosting an asset title 110. An entity managing a registry 104 may also charge a monthly holding fee, a fee for transferring ownership, a fee for inspecting the asset 108 associated with the asset title 110, a fee for updating an asset title 110, etc.

An asset title 110b may be updated. The registry 104 may communicate with a certifier 114. A certifier 114 may be a user device capable of generating a certification of title 116 using a certification of title creation module 160. Alternatively, a certifier 114 may be a person communicating through a user device. A certification of title 116 may be an electronic record that is added (as a sub-record) to the asset title 110 managed by the registry 104. The certifier 114 may use the certification of title creation module 160 to create a certification of title 116. The certification of title creation module 160 may work with the registry 104 to provide certification details to the registry 104. The certification of title 116 may include the certifier's digital signature, verifying the legitimacy of the certification of title 116.

In one configuration, the certification of title creation module 160 may be a separate application used only for creating a certificate of title 116. In another configuration, the certification of title creation module 160 may be part of a website managed by the registry 104. In yet another configuration, the certification of title creation module 160 may be a software program managed by the same entity that manages the registry 104; allowing the certifier 114 to send a physical certification of title 116 (i.e., a signed affidavit of authenticity) to the entity managing the registry 104.

The registry 104 may receive a certification of title 116 from the certifier 114. The certification of title 116 may be a statement of fact relating to the asset 108. For example, the certification of title 116 may state that the certifier 114 has seen the asset 108, used the asset 108, or inspected the asset 108 and found the asset 108 to be in the stated condition. A certifier 114 could be a trusted person such as a police officer or a judge, a person paid by the registry 104 to certify assets 108 or a person with a specialty relating to the asset 108 (such as a guitar technician certifying a repaired guitar). The certification of title 116 may also include the relative degree of importance of the certifier 114. For example, multiple certifiers 114 may each provide a certification of title 116 corresponding to the asset title 110. Each certification of title 116 may have a unique weight corresponding to the degree of expertise/trustworthiness of the certifier 114.

A certification of title 116 may assure a potential buyer of an unseen asset 108 that the seller has possession of the asset 108. For example, a certification of title 116 may assure a potential buyer of an unseen asset 108 that the asset 108 is indeed owned by the seller and/or that the asset 108 is in the warranted condition.

The registry 104 may be in electronic communication with a second user device 102b. The second user device 102b may communicate with the registry 104 through the network 111. The second user device 102b may include an asset title verification module 112. In one configuration, the asset title verification module 112 may be a webpage managed by the registry 104. The asset title verification module 112 may also be a program downloaded by the second user device 102b. The second user device 102b may be used to examine an asset title 110, certify an asset title 110 or initiate the transfer (selling or purchasing) of an asset title 110. The second user device 102b may also act as an escrow agent (by temporary taking possession of the asset title 110 and whatever is being given in exchange for the asset title 110 (e.g., money, another asset title 110)).

The asset title verification module 112 may request a copy of the asset title 110c. The copy of the asset title 110c may be an electronic copy of the asset title 110b (or portions of the asset title 110 (e.g., the copy of the asset title 110c may include or exclude certification records, associated images, documents)). Digital signatures may be used to verify the authenticity and accuracy of the copy of the asset title 110c. The copy of the asset title 110c may include encrypted data 118 so that only those user devices 102b with the appropriate private key can view the entirety of the copy of the asset title 110c. The copy of the asset title 110c may also include non-encrypted data 120 that can be viewed by anyone. Any modifications that are made using the copy of the asset title 110c would invalidate the digital signature, limiting the usefulness of the copy. Edits made to the copy of the asset title 110c are not incorporated back into the original asset title 110b.

The asset title verification module 112 may then determine the authenticity of the received asset title 110c. For example, the asset title verification module 112 may determine the level of certification corresponding to the asset title 110c. A copy of the asset title 110c may include both encrypted data 118 and non-encrypted data 120. For example, the encrypted data 118 may include sensitive information such as that concerning the authenticity of the asset title 110. The non-encrypted data 120 may include less sensitive information such as the certifications of title 110 and the relative weight for each certification of title 110. Thus, the asset title verification module 112 may only be able to examine the non-encrypted data 120 of the asset title 110. The asset title 110 may also include private but non-encrypted data 119 that has been marked “private” by the asset title owner.

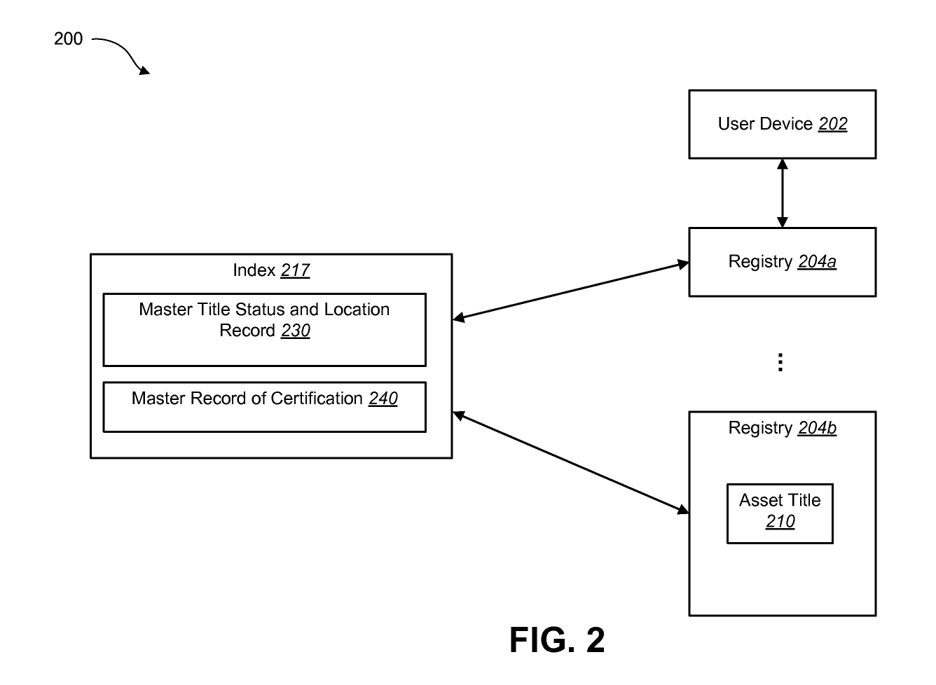

FIG. 2 is a block diagram illustrating a communication system 200 with an index 217. An index 217 may be a software application that provides a record (i.e., the master title status and location record 230) relating to the location and status of a particular asset title 210. An index 217 may communicate with multiple registries 204a,b. In one configuration, the index 217 may be on the same server as a registry 204 (and both the index 217 and the registry 204 may be controlled by the same entity). In another configuration, the index 217 may be located on a separate server (though likely in the same data center) as the registries 204.

As discussed above, each registry 204 may include a plurality of asset titles 210. Multiple registries 204 may be used to store asset titles 210 according to the type of asset 108, the management plan selected by the owner of the asset 108, the creation date of the asset title 210, etc. In one configuration, each of the registries 204 may be maintained by a different third-party; each of the registries may use a common index 217 (since the function of the index 217 is to resolve which registry 204 has which asset title 210). There may be multiple indexes 217 that are segregated by industry/commodity or business/government entity using the asset title technology.

The master status and location record 230 of asset titles 210 may be used to guarantee uniqueness of an asset title 210 for a given asset 108. The master status and location record 230 of asset titles 210 may be used to track which registry 204 currently maintains a particular asset title 210 and other management related information pertaining to the asset title 210. The asset title 210 related information contained within the master status and location record 230 may be obfuscated or limited by other means in order to protect privacy of the asset owner and enhance security. For instance, the master index 217 does not need to know what type of asset 108 an asset title 210 is associated with; instead the master index 217 only needs to know that there is a specific asset title 210 with a specific ID that is housed by a particular registry 204. Only a registry 204 may include the actual asset title 210.

The index 217 may include a master record of certification 240. The master record of certification 240 may include information relating to which asset title 210 was certified, the identity of the certifier 114 (which may be a digital signature certificate) and an identifier of the type of certification that was performed (e.g. ownership, current condition, etc.). The asset title 210 related information and certification 116 related information contained within the master record of certification 240 may be obfuscated or limited by other means in order to protect privacy and enhance security of the asset owner(s) and certifier 114. In one configuration, a separate master record of certification 240 may be created for each certification of each asset title 210.

The index 217 may communicate with one or more registries 204. For example, the index 217 may communicate with a first registry 204a and a second registry 204b. The registries 204 may direct user devices 202 searching for an asset title 210 to the index 217. For example, the first registry 204a may operate as a proxy registry to the index 217. A user device 202 seeking an asset title 210 may contact the first registry 204a. The first registry 204a may direct the user device 202 to the index 217. The index 217 may then direct the user device 202 to the second registry 204b that includes the desired asset title 210. The index 217 may also provide a basic report concerning the asset title 210 (i.e., the information related to the asset title 210 that is public) to either the requesting user device 202 or the requesting registry 204a. The user device 202 may contact the appropriate registry 204b to obtain the desired asset title 210.

When the index 217 or other registry 204b provides information relating to an asset title 210 to a user device 202 or registry 204a requesting information about the asset title 210, only the information that is non-encrypted 120 and not marked private may be revealed. If the user device 202 has purchased the asset title 210, all the information located within the asset title 210 may be revealed to the user device 202.

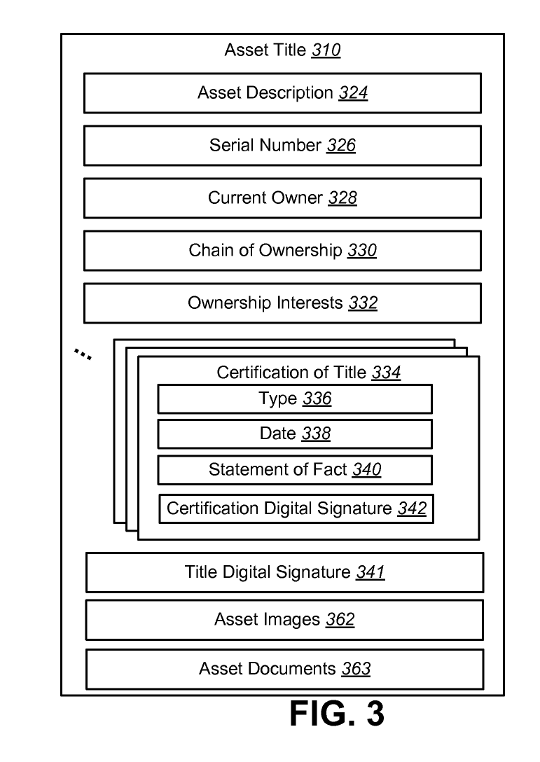

FIG. 3 is a block diagram illustrating an asset title 310 for use in the present systems and methods. The asset title 310 of FIG. 3 may be one configuration of the asset title 110 of FIG. 1. The asset title 310 may correspond to an asset 108. The data stored in an asset title 310 (i.e., the core data) may be stored in a relational database.

The asset title 310 may include an asset description 324. The asset description 324 may describe the asset 108 for identification purposes. The asset description 324 may include any facts or information that describes what the asset 108 is, the current and past condition of the asset 108, its purposes, etc., in the form of text, pictures, or other media. The asset title 310 may also include a serial number 326 or other unique identifier(s) for the corresponding asset 108. The asset title 310 may include a listing of the current owner(s) 328 of the asset 108. The asset title 310 may also include a listing of the chain of ownership 330 for the asset 108. The chain of ownership 330 may represent the history of prior ownership of the asset 108. Any sets or subsets of the information contained on the asset title 310 may be encrypted, non-encrypted, or non-encrypted but indicated as private.

The asset title 310 may include a listing of any ownership interests 332. For example, the ownership interests 332 may specify any lien holders, insurers or warranty providers of the asset 108. The listing of ownership interests 332 may also include detailed descriptions of the interests. The ownership interest 332 records may be actual contractual obligations relating to the asset 108. The asset title 310 may also include one or more certifications of title 334. A certification of title 334 may be a certification made by a certifier 114 concerning the asset 108. A certification of title 334 may include a certification type 336. A certification type 336 may describe the certification of title 334. For example, a certification type 336 may indicate that the certification of title 334 is an expert opinion or that the certification of title 334 is from a layperson.

A certification of title 334 may also include the date 338 of the certification of title 334. A certification of title 334 may further include a statement of fact 340. The statement of fact 340 may indicate what the certification of title 334 is certifying. For example, the statement of fact 340 may indicate that a certifier 114 saw the asset 108 in question. As another example, the statement of fact 340 may indicate that the certifier 114 saw a receipt for the asset 108 in question. The statement of fact 340 may also indicate any defects associated with the asset 108 and/or any special benefits associated with the asset 108. A certification of title 334 may further include a certification digital signature 342. The certification digital signature 342 may be used to verify that the certification of title 334 was issued by the certifier.

An asset title 310 may also include a title digital signature 341. The title digital signature 341 may be used to verify the asset title 310 as being an original (and not a copy) from the registry 204. The title digital signature 341 may be used by the registry 204. The title digital signature 341 and the certification digital signature 342 may be implemented using a Public Key Cryptography Standard #7 SignedData structure, an Extensive Markup Language (XML) signature or equivalent methods. An asset title 310 may further include asset images 362 (e.g., images of the asset, stock photos) and asset documents 363 (e.g., user manuals, instructions for use).

When the data in an asset title 310 is transmitted between registries 204 or to a user device 202, an XML file may be used. The data in an asset title 310 may also be temporarily represented as a JavaScript Object Notation (JSON) file for transmission to web-browser based applications. The XML file may contain all of the details associated with the asset title 310 (i.e., an identification of the asset 108, statements of fact 340 about the asset 108, the asset images 362 and asset documents 363). All of the details associated with the asset title 310 in an XML file may be digitally signed to prevent tampering. In one configuration, the entire XML file may be encrypted. In another configuration, only portions of the XML file may be encrypted.

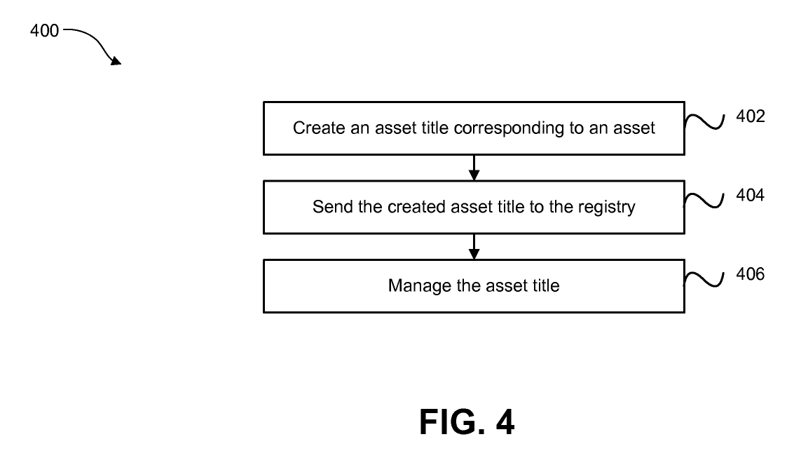

FIG. 4 is a flow diagram illustrating a method 400 for creating an asset title 110 corresponding to an asset 108. A user device 102a may create 402 an asset title 110 corresponding to an asset 108. A registry 104 may provide a web-based application for the user device 102a to create/manage asset titles 110. Client-applications may also be downloaded to personal computers and mobile devices that communicate with the registry 104 and allow the creation/management of asset titles 110.

In one configuration, an asset title 110 may be issued by the seller of the asset 108 at the point of sale. In this case, the asset title 110 may be created by the retailer and then transferred to the purchaser at the point of sale or soon after. The retailer may associate asset 108 related contracts or agreements (i.e., additional ownership interests) such as an original warranty, a purchased extended warranty to the asset title 110, a service plan, etc. Once an asset title 110 has been created, the owner of the asset title 110 may send 404 the created asset title 110 to a registry 104. The owner of the asset 108 (and thus the owner of the asset title 110) may then manage 406 the asset title 110. In one configuration, the owner of the asset 108 (i.e., the purchaser) may manage 406 the asset title 110 using the services provided by the registry 104. Managing 406 the asset title 110 may include transferring the asset title 110 to another registry 204b (if the terms allow for such). Managing 406 the asset title 110 may also include finding certifiers 114 willing to generate a certification of title 116 for the asset title 110. In one configuration, the registry 104 may be managed by the retailer. Managing 406 the asset title 110 may further include updating the asset title 110 to more accurately reflect the status of the asset 108. For example, if the asset 108 is a watch, the asset title 110 may be updated to indicate that the watch is missing a band or has a scratch.

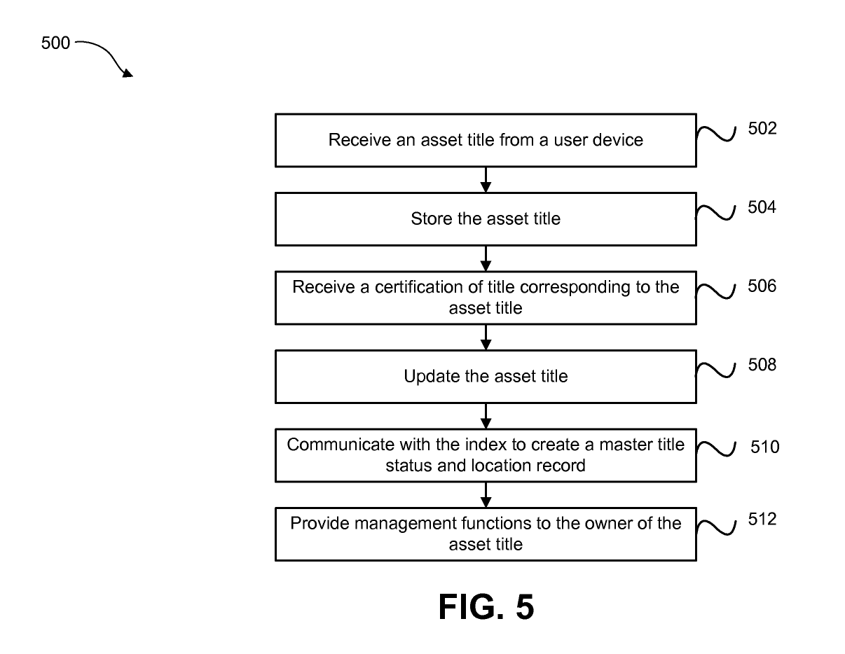

FIG. 5 is a flow diagram of a method 500 for hosting an asset title 110. The method 500 may be performed by a registry 104. In one configuration, the registry 104 may be a computing device. The registry 104 may receive 502 an asset title 110 from a user device 102a. The registry 104 may then store 504 the asset title 110. The registry 104 may receive 506 a certification of title 116 corresponding to the asset title 110 from a certifier 114. The registry 104 may then update 508 the asset title 110 accordingly. If the registry 104 has not received any certifications of title 116, the asset title 110 may exist without a certification of title 116.

The registry 104 may communicate 510 with an index 217 to create a master title status and location record 230 for the asset title 110. As discussed above, each asset title 110 may have a master title status and location record 230 located on the index 217. The registry 104 may also provide 512 management functions to the owner of the asset title 110. Management functions may include additional updating of the asset title 110 (e.g., adding additional statements of fact 340), assistance in selling the asset title 110 and transfer of the asset title 110 to a different registry 204b. The management functions may be performed utilizing the registry's services directly or via a user device 102b.

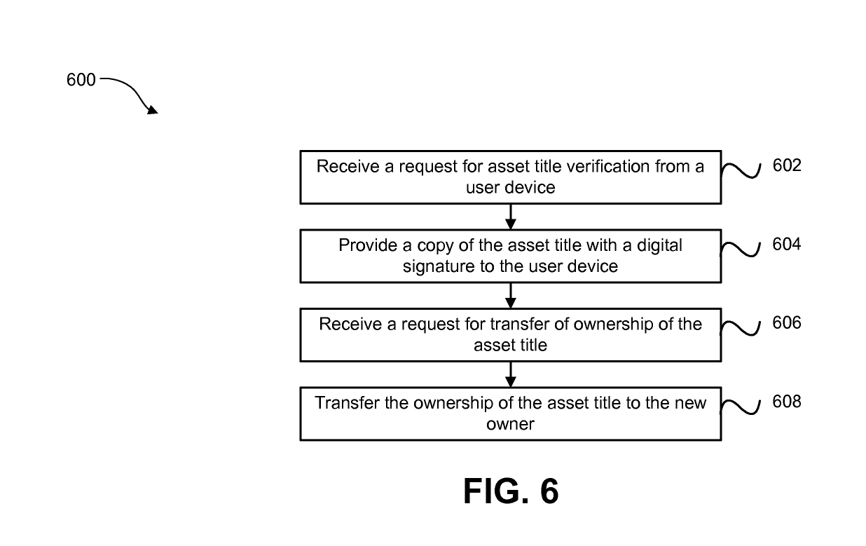

FIG. 6 is a flow diagram of a method 600 for providing assistance to the owner of an asset title 110 during a sale. The method 600 may be performed by a registry 104. The registry 104 may be a computing device. The registry 104 may receive 602 a request for asset title verification from a user device 102b. The user device 102b may be a potential buyer of the asset 108 (and the corresponding asset title 110). The user device 102b may also be the current owner of the asset 108.

The registry 104 may provide 604 a copy of the asset title 110c with a title digital signature 341 to the user device 102b. As discussed above, the copy of the asset title 110c may include both encrypted data 118 and non-encrypted data 120, depending on the service agreement arranged by the owner of the asset title 110. The title digital signature 341 may certify to the user device 102b that the copy provided is a copy of the original asset title 110b held by the registry 104.

The registry 104 may then receive 606 a request for the transfer of ownership of the asset title 110. The request for the transfer of ownership of the asset title 110 may be received from the owner of the asset title 110. In one configuration, the request for the transfer of ownership of the asset title 110 may be received from an escrow agent acting on behalf of the owner of the asset title 110. The registry 104 may transfer 608 ownership of the asset title 110 to the new owner.

The asset title 110 may be updated at or after the time of sale or transfer of ownership of the asset 108 to a new owner to correct and/or amend information on the asset title 110 relevant to the transfer (e.g., current ownership 328, chain of ownership 330). When an asset title 110 is transferred to a new owner (or owners) it may remain within the same registry 204a or be transferred to a new registry 204b, with which the new owner(s) have a relationship. At the time of transfer, the index 217 may be contacted by the involved registry(s) to update the master title status and location record 230 relating to the asset title 110.

In order to protect both the buyer(s) and seller(s) of an asset 108 during the time of sale (or other transfer) of the asset 108, an independent entity may be involved to facilitate the transfer through the use of escrow. In such cases, the escrowing entity may receive the asset title 110 for the asset 108 from the seller(s), and the funds (or other agreed upon payments/requirements) from the buyer(s). The buyer(s) may then be allowed time to verify that the asset title 110 is for the agreed upon asset 108, and that it includes sufficient certifications of title 116 to meet their satisfaction. If the buyer(s) are satisfied, the escrowing entity may simultaneously release payment to the seller(s) and transfer the asset title 110 to the buyer(s). This reduces the risk to both buyer(s) and seller(s) that the other party may not meet their end of the bargain.

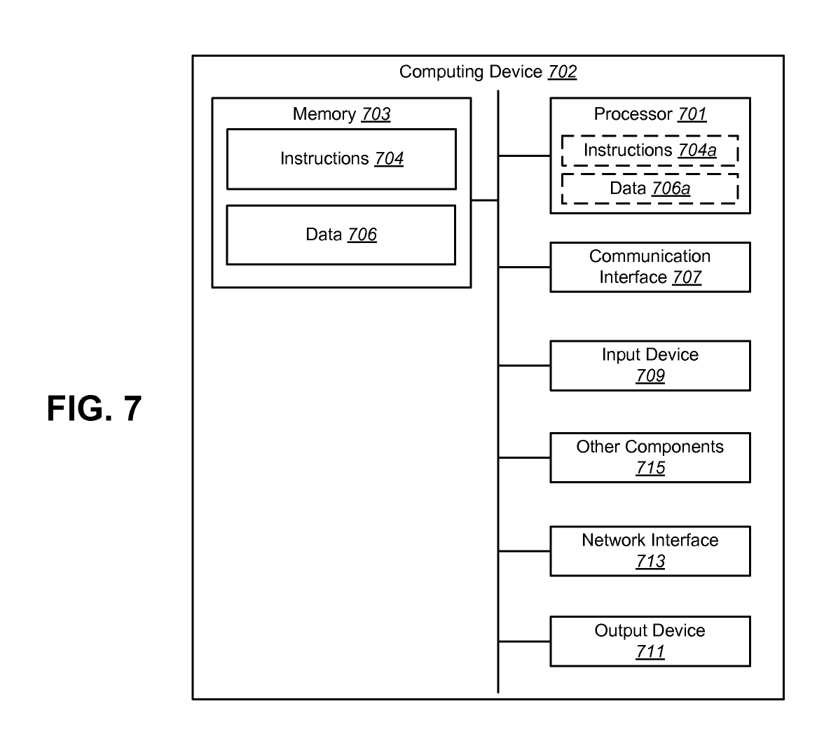

FIG. 7 is a block diagram illustrating various components that may be utilized in a computing device 702. The computing device 702 may be a user device 102, a registry 104, or a certifier 114. Although only one computing device 702 is shown, the configurations herein may be implemented in a distributed system using many computer systems. Computing devices 702 may include the broad range of digital computers including microcontrollers, hand-held computers, personal computers, servers, mainframes, supercomputers, minicomputers, workstations, and any variation or related device thereof.

The computing device 702 is shown with a processor 701 and memory 703. The processor 701 may control the operation of the computing device 702 and may be embodied as a microprocessor, a microcontroller, a digital signal processor (DSP) or other device known in the art. The processor 701 typically performs logical and arithmetic operations based on program instructions 704 stored within the memory 703. The instructions 704 in the memory 703 may be executable to implement the methods described herein.

The computing device 702 may also include one or more communication interfaces 707 and/or network interfaces 713 for communicating with other electronic devices. The communication interface(s) 707 and the network interface(s) 713 may be based on wired communication technology, and/or wireless communication technology.

The computing device 702 may also include one or more input devices 709 and one or more output devices 711. The input devices 709 and output devices 711 may facilitate user input/user output. Other components 715 may also be provided as part of the computing device 702.

Data 706 and instructions 704 may be stored in the memory 703. The processor 701 may load and execute instructions 704a from the instructions 704 in memory 703 to implement various functions. Executing the instructions 704 may involve the use of the data 706a that is stored in the memory 703. The instructions 704 are executable to implement one or more of the processes or configurations shown herein, and the data 706 may include one or more of the various pieces of data described herein.

The memory 703 may be any electronic component capable of storing electronic information. The memory 703 may be embodied as random access memory (RAM), read only memory (ROM), magnetic disk storage media, optical storage media, flash memory devices in RAM, on-board memory included with the processor, EPROM memory, EEPROM memory, an ASIC (Application Specific Integrated Circuit), registers, and so forth, including combinations thereof.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 4, 5 and 6, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for hosting an asset title, comprising:
receiving an asset title from a first user device;
storing the asset title; and
communicating with an index to create a master title status and location record.

2. The method of claim 1, further comprising:
receiving a certification of title from a certifier; and
updating the asset title according to the received certification of title.

3. The method of claim 1, further comprising:
providing management functions to an owner of the asset title.

4. The method of claim 1, further comprising:
receiving a request for asset title verification from a second user device; and
providing a copy of the asset title to the user device, wherein the copy of the asset title comprises a digital signature that validates the authenticity and accuracy of the copy of the asset title.

5. The method of claim 1, wherein the asset title comprises an asset description.

6. The method of claim 1, wherein the asset title comprises a serial number that uniquely identifies an asset associated with the asset title.

7. The method of claim 1, wherein the asset title comprises a listing of a current owner of the asset.

8. The method of claim 1, wherein the asset title comprises a listing of the chain of ownership of the asset.

9. The method of claim 1, wherein the asset title comprises the ownership interests of an asset associated with the asset title.

10. The method of claim 1, wherein the asset title comprises information related to additional contracts pertaining to an asset associated with the asset title.

11. The method of claim 1, wherein the asset title comprises one or more certifications of title.

12. The method of claim 11, wherein a certification of title comprises a type of certification, a date of certification, and a statement of fact for the certification of title.

13. The method of claim 4, wherein providing the asset title to the user device comprises utilizing an index to locate the registry hosting the asset title.

14. The method of claim 4, wherein the copy of the asset title comprises encrypted information.

15. The method of claim 2, wherein an index is used to track certifier activities across all asset titles known to the index.

16. The method of claim 15, wherein the index is used to track certifier reputation and expertise relating to the certification of asset titles.

17. The method of claim 1, wherein updating and transferring the asset title at the time of transfer of ownership of the asset is facilitated by an entity providing escrow services, wherein the asset title is not transferred to a new owner until conditions of the seller are met, and wherein payment is not made until conditions of the buyer are met.

18. An apparatus configured for hosting an asset title, comprising:
a processor;
memory in electronic communication with the processor; and
instructions stored in the memory, the instructions being executable by the processor to:
receive an asset title from a first user device;
store the asset title; and
communicate with an index to create a master title status and location record.

19. A method for generating an asset title, comprising:
creating an asset title corresponding to an asset;
sending the created asset title to a first registry; and
managing the asset title.

20. The method of claim 19, wherein the asset title is created using a web-based application provided by the first registry.

21. The method of claim 19, wherein the asset title is created using an application downloaded from the first registry.

22. The method of claim 19, wherein the method is performed by a user device.

23. The method of claim 19, wherein managing the asset title comprises finding a certifier willing to generate a certification of title for the asset title.

24. The method of claim 19, wherein managing the asset title comprises transferring the asset title to a second registry.

25. The method of claim 19, wherein managing the asset title comprises updating the asset title to more accurately reflect the status of the asset.

26. The method of claim 19, wherein the method is performed by a retailer at a point of sale of the asset.

27. The method of claim 26, wherein additional ownership interests are added to the asset title at the point of sale.

28. A wireless device configured for generating an asset title, comprising:
a processor;
memory in electronic communication with the processor; and
instructions stored in the memory, the instructions being executable by the processor to:
create an asset title corresponding to an asset;
send the created asset title to a first registry; and
manage the asset title.
